(19) United States
(12) Patent Application Publication
(10) Pub. No.: US 2026/0276514 A1
(43) Pub. Date: Sep. 17, 2026

(54) DETECTOR APPARATUS AND METHOD FOR OPERATING A DETECTOR APPARATUS

(71) Applicant: Robert Bosch GmbH, Stuttgart (DE)

(72) Inventors: Carsten Reichert, Gomaringen (DE); Thomas Alexander Schlebusch, Renningen (DE); Johannes Meyer, Haseluenne (DE)

(21) Appl. No.: 19/560,799

(22) Filed: Mar. 9, 2026

(30) Foreign Application Priority Data
Mar. 12, 2025 (DE) 10 2025 109 340.7
Feb. 13, 2026 (DE) 10 2026 106 108.7

(51) Int. Cl. G01N 15/075; G01N 15/00; G01N 21/47; G02B 1/00

(52) U.S. Cl. CPC G01N 15/075; G02B 1/002; G01N 2015/0003; G01N 21/47; G01N 2021/4709

(57) ABSTRACT

A detector apparatus. The detector apparatus includes a laser device that generates a laser beam. The detector apparatus includes a beam-splitting device that generates a plurality of non-collinear measurement laser beams from the laser beam and emits the measurement laser beams in predefined directions. A receiving device receives the measurement laser beams scattered by particles in the surroundings of the detector apparatus and generates a measurement signal. An evaluation device evaluates the measurement signal. The detector apparatus can be provided for two-dimensional detection. The plurality of measurement laser beams then comprises at least three measurement laser beams. The detector apparatus can be provided for three-dimensional detection, and the plurality of measurement laser beams then includes at least six measurement laser beams.

### CROSS REFERENCE

The present application claims the benefit under 35 U.S.C. § 119 of Germany Patent Application No. DE 10 2025 109 340.7 filed on Mar. 12, 2025, and Germany Patent Application No. DE 10 2026 106 108.7 filed on Feb. 13, 2026, which are expressly incorporated herein by reference in their entireties.

### FIELD

The present disclosure relates to a detector apparatus and to a method for operating a detector apparatus. In particular, the present disclosure relates to a detector apparatus for determining a particle density.

### BACKGROUND INFORMATION

Particle sensors are used to measure and quantify the particle load of air. Here, the number of particles per measurement volume is frequently determined, wherein only particles below a specified size are taken into consideration in order to distinguish between coarse dust, fine dust and ultrafine dust. Such measurements are essential in order, for example, to monitor emissions of industrial installations or compliance with statutory limit values in the automotive sector.

In addition, the demand for particularly compact particle sensors is increasing in order to save weight and installation space. As a result, the independent measurement of the local particle load is also possible, for example, with portable devices such as smartphones, tablets, laptops or wearables.

Germany Patent Application No. DE 10 2018 222 590 A1 describes a method for determining the absolute value of the flow velocity of a medium that transports particles. Germany Patent Application No. DE 10 2018 213 932 A1 relates to a method for operating an optical particle sensor apparatus.

### SUMMARY

The present disclosure provides a detector apparatus and a method for operating a detector apparatus.

Preferred example embodiments are disclosed herein.

According to a first aspect, the present disclosure relates to a detector apparatus having a laser device that generates a laser beam. According to an example embodiment, the detector apparatus comprises a beam-splitting device that generates a plurality of non-collinear measurement laser beams from the laser beam and emits the measurement laser beams in predefined directions. A receiving device receives the measurement laser beams scattered by particles in the surroundings of the detector apparatus and generates a measurement signal. An evaluation device evaluates the measurement signal. In particular, the evaluation device is configured to evaluate interference patterns that result from a superposition of the emitted measurement laser beams with the scattered measurement laser beams that are backscattered in the direction of the laser device in this case. The detector apparatus can be provided for two-dimensional detection. The plurality of measurement laser beams then comprises at least three measurement laser beams. The detector apparatus can be provided for three-dimensional detection, and the plurality of measurement laser beams then comprises at least six measurement laser beams.

In the case of two-dimensional detection, a beam path of the at least three measurement laser beams extends in a plane, i.e., in this case, the predefined directions in which the three measurement laser beams are emitted form a plane.

In the case of three-dimensional detection, a beam path of the at least six measurement laser beams extends in space, i.e., at least one of the at least six measurement laser beams is not arranged in the same plane as at least five of the at least six measurement laser beams.

According to a second aspect, the present disclosure relates to a method for operating a detector apparatus. According to an example embodiment, a laser beam is generated by a laser device of the detector apparatus, wherein a beam-splitting device of the laser device generates a plurality of non-collinear measurement laser beams and emits them in predefined directions. The measurement laser beams scattered by particles in the surroundings of the detector apparatus are received by a receiving device, and a measurement signal is generated. The measurement signal is evaluated by an evaluation device. The detector apparatus can be operated for two-dimensional detection. The plurality of measurement laser beams then comprises at least three measurement laser beams. The detector apparatus can be operated for three-dimensional detection, and the plurality of measurement laser beams then comprises at least six measurement laser beams.

The detector apparatus preferably requires only a single chip for emitting a laser beam, as a result of which material costs are reduced. Nevertheless, ambiguities can be avoided by the number of measurement laser beams.

According to one example embodiment of the detector apparatus, the foci of the measurement laser beams are located in a plane. Under the assumption that the air flow relative to the measurement volume can be assumed to be macroscopic and thus laminar, the flow velocity of the particles can be ascertained.

According to one example embodiment of the detector apparatus, the foci of the measurement laser beams are distributed uniformly on a circle in the plane. In particular, there are preferably no three measurement laser beams that are coplanar.

According to one example embodiment of the detector apparatus, the foci of the measurement laser beams are located on a triangle. A focus of one of the measurement laser beams is located at each corner of the triangle. A focus of one of the measurement laser beams is located at a midpoint of each edge of the triangle. In particular, three measurement laser beams can be emitted along orthogonal axes, and three further measurement laser beams can be emitted along angle bisectors of two of the measurement laser beams in each case.

According to one example embodiment of the detector apparatus, the beam-splitting device comprises at least one component having meta-optical elements. Meta-optical elements (MOE) or metasurfaces are arrangements of elements that can shift phases and therefore can change the wavefront and the polarization. It is therefore possible to generate a desired distribution of measurement laser beams. The measurement laser beams can be focused on specified points in space.

According to one example embodiment of the detector apparatus, the beam-splitting device comprises a first component having meta-optical elements that split the laser beam into discrete diffraction orders. The beam-splitting device further comprises a second component having meta-optical elements that focus the diffraction orders, in each case, onto a point in space. In particular, the measurement laser beams can also all be focused onto exactly one point by the second component having meta-optical elements. As a result, a desired distribution of the measurement laser beams can be achieved.

If the detector apparatus is additionally configured so that the foci of the measurement laser beams are distributed uniformly on a circle in the plane, particularly high intensities result for the measurement laser beams, since the meta-optical element or the meta-optical elements can in this case be configured so that they absorb a very small proportion of the laser beam.

According to one example embodiment of the detector apparatus, the evaluation device ascertains, based on the measurement signal, a flow velocity of the particles and/or a particle density of the particles. In particular, the particle density can be ascertained from the flow velocity.

According to one example embodiment of the detector apparatus, the evaluation device ascertains absolute values of velocity components as projections of the flow velocity onto measurement directions that correspond to the measurement laser beams.

According to one example embodiment of the detector apparatus, the evaluation device evaluates the measurement signal by means of an artificial neural network. The artificial neural network can output a flow velocity of the particles and/or a particle density of the particles.

Further advantages, features, and details of the present disclosure will become apparent from the following description, in which various exemplary embodiments are described in detail with reference to the figures.

### BRIEF DESCRIPTION OF THE DRAWINGS

FIG. 1 shows a block diagram of a detector apparatus according to an example embodiment of the present disclosure.

FIG. 2 shows predefined directions of the measurement laser beams according to an example embodiment of the present disclosure.

FIG. 3 shows predefined directions of the measurement laser beams according to a further example embodiment of the present disclosure.

FIG. 4 shows predefined directions of the measurement laser beams according to a further example embodiment of the present disclosure.

FIG. 5 shows a flow chart of a method for operating a detector apparatus, according to an example embodiment.

The numbering of method steps serves the purpose of clarity and is generally not intended to imply a specific chronological order. In particular, a plurality of method steps may also be carried out simultaneously.

### DETAILED DESCRIPTION OF EXAMPLE EMBODIMENTS

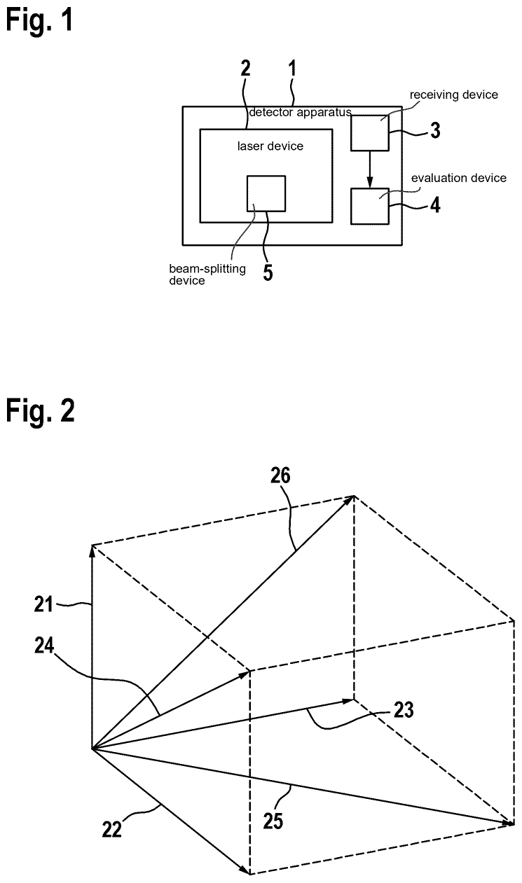

FIG. 1 shows a block diagram of a detector apparatus 1, which can be integrated into a mobile device, for example into a surface of a smartphone, or into a tablet, a laptop or a wearable.

The detector apparatus 1 comprises a laser device 2 that generates a laser beam. For this purpose, the laser device 2 can comprise a laser diode, for example a VCSEL (vertical cavity surface emitting laser). The laser device 2 comprises a beam-splitting device 5 that generates a plurality of non-collinear measurement laser beams from the laser beam and emits them in predefined directions.

The beam-splitting device 5 can comprise at least one component having meta-optical elements. The beam-splitting device 5 can, for example, comprise a first component having meta-optical elements that split the laser beam into discrete diffraction orders. The beam-splitting device can further comprise a second component having meta-optical elements that focus the diffraction orders, in each case, onto a point in space. As a result, a plurality of measurement laser beams is generated, in each case one measurement laser beam per diffraction order.

The detector apparatus 1 can be provided for two-dimensional detection. At least three measurement laser beams are then generated. The detector apparatus can be provided for three-dimensional detection, wherein at least six measurement laser beams are generated.

A receiving device 3 receives the measurement laser beams scattered by particles in the surroundings of the detector apparatus 1 and generates a measurement signal. An evaluation device 4 evaluates the measurement signal. For example, the evaluation device 4 ascertains absolute values of velocity components as projections of the flow velocity onto measurement directions that correspond to the measurement laser beams. The evaluation device 4 can ascertain, based on the measurement signal, a flow velocity of the particles and/or a particle density of the particles (i.e., particles per volume).

The measurement signal can comprise a spectrum, for example the amplitude distribution according to a frequency shift of the received measurement laser beams. The spectrum can be calculated based on a fast Fourier transform (FFT). The evaluation device 4 can contain a memory, wherein the measurement signal or the spectrum can be averaged over a longer period of time based on data stored in the memory.

All particles observed by the three measurement laser beams correspond to observation measurements of projections of the same velocity vector into the Doppler frequency space. The Doppler frequencies correspond to the projection of the desired velocity vector onto the direction vector associated with the particular measurement laser beam. The evaluation device 4 can ascertain peaks in the spectrum. From the predefined directions of the measurement laser beams, a system of equations for the components of the velocity vector follows, which the evaluation device 4 can solve according to the peaks in order to calculate the velocity vector and thus the flow velocity of the particles.

The evaluation device 4 can also evaluate the measurement signal by means of an artificial neural network, which outputs, for example, the flow velocity of the particles or a particle density.

According to one embodiment of the detector apparatus, the evaluation device 4 can additionally use the amplitude ratio of the individual Doppler frequency observations (peaks) for calculating the resulting velocity vector.

FIG. 2 shows possible predefined directions of measurement laser beams 21 to 26. For this purpose, three mutually orthogonal measurement laser beams 21, 22, 23 are provided, and, for in each case two of the orthogonal measurement laser beams 21, 22, 23, a further measurement laser beam 24, 25, 26 is emitted along the angle bisector.

When using only a single laser beam, the superposition of the Doppler frequencies of all measurement laser beams is observed. If, in two dimensions, only two measurement laser beams were to be used, there would be an ambiguity if only one peak is observed in the spectrum. Such an observation could occur in the case of a particle flow along the angle bisector, wherein the projection onto both measurement directions is identical and thus contributes to a peak at the same frequency. However, the observation could also occur in the case of a particle flow having a reduced velocity along the direction of one of the two measurement laser beams. The contribution of this measurement laser beam yields the peak, and the projection onto the second measurement laser beam yields a Doppler frequency of 0 degrees, which, however, is not observed, since the zero contribution (DC component) is typically suppressed.

By additionally emitting a further laser beam in each case along the angle bisector, the ambiguity can be resolved, since the spectra now differ sufficiently. In the case of a particle flow along the angle bisector, a second peak at a higher frequency, corresponding to a higher velocity, now occurs, which corresponds to the projection onto the measurement laser beam along the angle bisector.

Analogously, it is possible to perform two-dimensional detection. In this case, three coplanar but non-collinear measurement laser beams are emitted.

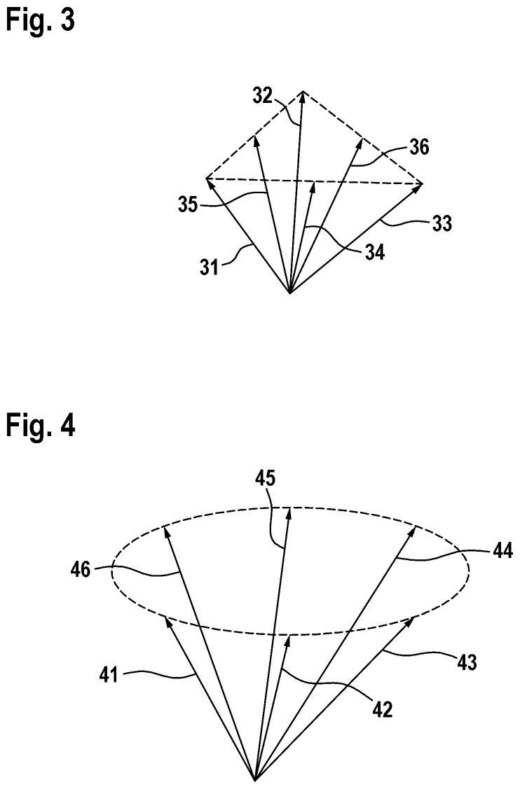

FIG. 3 shows possible predefined directions of measurement laser beams 31 to 36. The focus of each measurement laser beam 31 to 36 is located in a common plane, wherein the foci are located on a preferably equilateral triangle. A focus of one of the measurement laser beams 31 to 33 is located at each corner of the triangle. A focus of a further one of the measurement laser beams 34 to 36 is located at a midpoint of each edge of the triangle. The orientation of the measurement laser beams shown in FIG. 3 can result from the emission of the measurement laser beams shown in FIG. 2.

FIG. 4 shows possible predefined directions of measurement laser beams 41 to 46. The foci of the measurement laser beams 41 to 46 are distributed uniformly on a circle in a plane. The angles between two foci in the plane relative to the center of the circle thus in each case amount to 360°/6=60°.

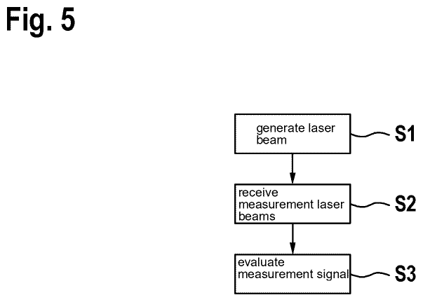

FIG. 5 shows a flow chart of a method for operating a detector apparatus, for example the detector apparatus 1 illustrated in FIG. 1.

In a first method step S1, a laser beam is generated by a laser device 2 of the detector apparatus 1, wherein a beam-splitting device 5 of the laser device 2 generates a plurality of non-collinear measurement laser beams 21-26, 31-36, 41-46 and emits them in predefined directions.

In a second method step S2, the measurement laser beams 21-26, 31-36, 41-46 scattered by particles in the surroundings of the detector apparatus 1 are received by a receiving device 3, and a measurement signal is generated. For generating the measurement signal, the memory of the evaluation device 4 can be used so that a measurement signal averaged over a defined period of time or over a sliding window is output.

In a third method step S3, the measurement signal is evaluated by an evaluation device 4.

The detector apparatus 1 can be operated for two-dimensional detection. The plurality of measurement laser beams then comprises at least three measurement laser beams. The detector apparatus 1 can be operated for three-dimensional detection, and the plurality of measurement laser beams then comprises at least six measurement laser beams.

What is claimed is:

1. A detector apparatus, comprising:
a laser device configured to generate a laser beam;
a beam-splitting device configured to generate, from the laser beam, a plurality of non-collinear measurement laser beams and to emit the plurality of non-collinear measurement laser beams in predefined directions;
a receiving device configured to receive the measurement laser beams scattered by particles in surroundings of the detector apparatus and to generate a measurement signal; and
an evaluation device configured to evaluate the measurement signal;
wherein: (i) the detector apparatus is provided for two-dimensional detection and the plurality of non-collinear measurement laser beams includes at least three measurement laser beams, or (ii) the detector apparatus is provided for three-dimensional detection and the plurality of non-collinear measurement laser beams includes at least six measurement laser beams.

2. The detector apparatus according to claim 1, wherein foci of the plurality of non-collinear measurement laser beams are located in a plane.

3. The detector apparatus according to claim 2, wherein the foci of the plurality of non-collinear measurement laser beams are distributed uniformly on a circle in the plane.

4. The detector apparatus according to claim 2, wherein the foci of the plurality of non-collinear measurement laser beams are located on a triangle, wherein a focus of one of the plurality of non-collinear measurement laser beams is located at each corner of the triangle, and wherein a focus of each of others of the measurement laser beams is located at a midpoint of each edge of the triangle.

5. The detector apparatus according to claim 1, wherein the beam-splitting device includes at least one component having meta-optical elements.

6. The detector apparatus according to claim 5, wherein the beam-splitting device includes a first component having meta-optical elements, which is configured to split the laser beam into discrete diffraction orders, and includes a second component having meta-optical elements, which is designed to focus each of the diffraction orders onto a point in space.

7. The detector apparatus according to claim 1, wherein the evaluation device is configured to ascertain, based on the measurement signal, at least one of: (i) a flow velocity of the particles, or (ii) a particle density of the particles.

8. The detector apparatus according to claim 7, wherein the evaluation device is configured to ascertain absolute values of velocity components as projections of the flow velocity onto measurement directions corresponding to the measurement laser beams.

9. The detector apparatus according to claim 1, wherein the evaluation device is configured to evaluate the measurement signal using an artificial neural network.

10. A method for operating a detector apparatus, the method comprising the following steps:
generating a laser beam by a laser device of the detector apparatus, wherein a beam-splitting device of the laser device generates a plurality of non-collinear measurement laser beams and emits the plurality of non-collinear measurement laser beams in predefined directions;
receiving the measurement laser beams scattered by particles in the surroundings of the detector apparatus by a receiving device, and generating a measurement signal; and
evaluating the measurement signal by an evaluation device;
wherein one of: (i) the detector apparatus is operated for two-dimensional detection and the plurality of non-collinear measurement laser beams includes at least three measurement laser beams, or (ii) wherein the detector apparatus is operated for three-dimensional detection and the plurality of non-collinear measurement laser beams includes at least six measurement laser beams.
